(19) United States
(12) Patent Application Publication
(10) Pub. No.: US 2026/0113346 A1
(43) Pub. Date: Apr. 23, 2026

(54) SYSTEM AND METHOD FOR ARTIFICIAL INTELLIGENCE-DRIVEN ANOMALY DETECTION IN ENCRYPTED NETWORK TRAFFIC WITHOUT DECRYPTION

(71) Applicant: Sri Ranganath SEELAM, San Jose, CA (US)

(72) Inventor: Sri Ranganath SEELAM, San Jose, CA (US)

(21) Appl. No.: 19/425,437

(22) Filed: Dec. 18, 2025

(51) Int. Cl. H04L 9/40

(52) U.S. Cl. CPC H04L 63/1425; H04L 63/20

(57) ABSTRACT

A system and method for detecting anomalies in encrypted network traffic without decrypting encrypted payloads is disclosed. The invention comprises a hardware-accelerated pipeline including a packet acquisition unit configured to extract observable header attributes and timestamp values, a signal analysis unit implemented using digital signal processing circuitry to generate temporal and spectral characteristics of encrypted packet flows, and a morphometric extraction unit that produces encrypted-flow descriptors based on statistical dispersion, burst patterns, and ciphertext variability. A behavioral graph construction unit generates graph-structured representations of encrypted flows using incremental state-transition encoding. An artificial-intelligence inference unit employing a tensor-processing processor performs multi-stage anomaly analysis through temporal reconstruction, attention-based weighting of descriptors, and graph-structural deviation assessment to compute anomaly scores without decrypting any payload. A secure response control unit evaluates the scores against policy thresholds and performs mitigation actions while preserving confidentiality.

### TECHNICAL FIELD OF THE INVENTION

The present invention relates to network security systems, and more specifically to an Artificial Intelligence (AI)-driven system and method for detecting anomalies, cyber-attacks, and malicious behavioral patterns within encrypted network traffic without requiring decryption. The invention further pertains to specialized hardware structures and devices that enable real-time flow feature extraction, side-channel signal processing, and machine-learning-based inference on encrypted packet streams while preserving data confidentiality.

### BACKGROUND OF THE INVENTION

Modern network infrastructures increasingly rely on encryption to ensure data confidentiality; however, encryption also obstructs traditional deep packet inspection techniques used to detect cyber threats. Attackers exploit this limitation by tunneling malicious payloads and command-and-control traffic through TLS, QUIC, SSH, and custom encrypted channels, thereby bypassing conventional security gateways. Existing anomaly detection techniques struggle with encrypted traffic because they depend either on decrypting the stream—thereby violating privacy requirements and increasing latency—or on using shallow statistical models that cannot accurately characterize complex temporal behavior. Accordingly, there exists a need for a technical solution that performs accurate, real-time anomaly detection in fully encrypted network traffic without decryption, while maintaining compliance with data-protection constraints, sustaining high throughput, and being implementable as a hardware-accelerated device suitable for deployment at gateways, routers, IoT hubs, satellite links, and edge computing environments.

The rapid evolution of encrypted communication has transformed the landscape of network security, creating both unprecedented protections for user privacy and profound challenges for defenders attempting to identify malicious activity. Historically, network monitoring systems were built around deep packet inspection approaches that relied on the ability to parse application-layer content, analyze protocol semantics, and observe payload-level anomalies. Even metadata fields once considered stable indicators—such as TLS handshake parameters—are increasingly encrypted or obfuscated. This shift has driven the research and industry community to explore alternative inspection and anomaly detection methods that operate on encrypted traffic without compromising privacy or performance. Yet despite considerable progress, existing solutions remain insufficient for addressing current threat landscapes, particularly sophisticated command-and-control channels, covert exfiltration mechanisms, and encrypted malware communication that intentionally mimics benign encrypted patterns.

One of the earliest responses to encrypted-traffic blindness was the emergence of flow-based monitoring systems that relied on aggregated statistical data extracted from packet headers. These systems, typically derived from NetFlow, IPFIX, or sFlow exports, analyze attributes such as source and destination IP addresses, port numbers, byte counts, packet counts, and flow durations. While useful for coarse-grained anomaly detection, these flow-based approaches suffer from inherent lack of granularity. Since flow summaries abstract away packet-level timing, burst patterns, and size sequences—attributes critical for differentiating malicious encrypted traffic—the resulting detection accuracy is limited. Attackers can easily evade such systems by padding traffic to approximate normal flow sizes, fragmenting data transfers, or adjusting communication intervals. Flow-based systems also struggle with real-time detection because exports occur at configurable intervals, meaning anomalies may only be detected after significant delay. Moreover, these approaches require correlation across flows from multiple devices or vantage points, which introduces synchronization challenges and substantial overhead in distributed environments.

Another category of existing solutions involves statistical fingerprinting of encrypted traffic. These methods attempt to characterize encrypted sessions based on packet length sequences, inter-arrival timings, TLS handshake features, and other observable metadata. Early work in this area achieved moderate success in traffic classification, such as distinguishing video streams from web browsing or VoIP calls. However, these techniques were not designed for security and have proven fragile when confronted with active adversaries. Modern malware frameworks actively randomize or shape encrypted packet sizes to evade fingerprinting, and encrypted protocols like TLS 1.3 encrypt most handshake parameters that earlier systems relied on. As connections increasingly use session resumption, ESNI/Encrypted ClientHello, GREASE values, and traffic-analysis-resistant padding, many traditional fingerprinting methods lose discriminative power. Furthermore, these techniques often assume stationarity in traffic patterns, whereas modern cloud-native applications exhibit dynamic, bursty, and adaptive behavior that confuses static statistical models.

Machine learning-based encrypted traffic classifiers represent another major direction in existing research. Early ML approaches utilized random forests, SVM models, and Bayesian classifiers trained on manually crafted flow features. These models, however, require extensive feature engineering, which is time-consuming and brittle under adversarial conditions. More recent solutions have explored deep learning architectures, including CNNs, RNNs, autoencoders, and transformer networks applied to packet-length sequences or time-series metadata. While deep learning models outperform classical approaches in certain conditions, they face significant deployment constraints. Many require raw packets to be parsed and preprocessed extensively, introducing computational overhead that makes them unsuitable for high-throughput environments such as backbone routers or data-center gateways. Additionally, deep learning models trained on specific datasets generalize poorly across networks due to variations in traffic behavior, device types, and encryption settings. Publicly available datasets are typically limited in realism, often generated in controlled lab environments and lacking the diversity needed for production-grade detection. Consequently, real-world ML-based systems frequently exhibit high false-positive and false-negative rates, preventing their widespread adoption.

Another category of prior solutions includes TLS interception systems that perform decryption through man-in-the-middle proxies. While effective from a security standpoint, this approach introduces substantial privacy concerns, regulatory liabilities, and operational complexity. TLS interception requires installing trusted root certificates on endpoint devices, maintaining key management infrastructure, and assumes user consent for decryption. This architecture is fundamentally incompatible with modern privacy laws including GDPR, HIPAA, PCI-DSS, and many governmental data-sovereignty regulations. It also degrades performance, adds substantial latency, and risks exposing decrypted sensitive data if the interception appliance is compromised. For high-security environments such as financial institutions or critical infrastructure networks, TLS interception is often legally prohibited, making it an infeasible solution.

Network Intrusion Detection Systems (NIDS) have also attempted to adapt by shifting focus from payload content to transport-layer metadata. Systems such as Suricata, Zeek, and Snort now include limited encrypted-traffic analysis capabilities, such as rule-based detection of suspicious port usage or abnormal frequency of short-lived TLS sessions. However, these rule-based systems heavily depend on signature definitions crafted manually by analysts. As threats evolve rapidly, signature-based approaches struggle to detect zero-day attacks and sophisticated threat actors who intentionally randomize communication patterns. Moreover, signature-based methods cannot capture subtle behavioral anomalies present only in long-term temporal correlations or high-dimensional statistical patterns, both of which are better suited to machine-learning-driven inference.

Emerging privacy-preserving analytics techniques attempt to bridge this gap through methods such as homomorphic encryption, secure multi-party computation, or federated learning. While academically promising, these approaches remain impractical for real-time network security because of extreme computational cost, limited model expressiveness, or the requirement to aggregate data from distributed participants with incompatible policies. Homomorphic encryption, for example, incurs orders-of-magnitude performance penalties that make it unsuitable for gigabit-scale traffic inspection. Federated learning systems reduce centralization risks but cannot directly process raw encrypted traffic, depending instead on endpoint-side cooperation—which attackers can bypass or poison.

Side-channel analysis approaches represent another class of attempts to analyze encrypted traffic. These techniques model secondary artifacts such as timing jitter, TCP congestion-window behavior, TLS handshake latency, and packet-size variance. Research has demonstrated that certain forms of exfiltration produce measurable spectral signatures or perturb protocol state machines in detectable ways. However, existing side-channel-based detection techniques lack robustness because they analyze features in isolation rather than combining them with cross-layer metadata or long-range temporal dependencies. Furthermore, side-channel features are highly sensitive to network conditions such as congestion, jitter, and hardware acceleration differences, leading to inconsistent performance across deployment environments. They also require precise timestamping, which many software-based monitoring systems cannot guarantee due to OS scheduling delays and CPU-based timestamp inaccuracies.

Behavioral graph analysis has recently emerged as a promising approach for modeling complex interactions in encrypted communication. These systems represent packet flows and state transitions as graph structures and attempt to detect anomalies based on deviations from expected interaction patterns. However, existing graph-based systems generally operate offline due to the expensive graph construction and inference process. They rely on CPU-bound libraries unsuitable for deployment at multi-gigabit or terabit per-second network edges. Additionally, existing graph anomaly detection methods struggle with streaming data because they assume access to complete graphs before analysis, which contradicts the continuous nature of real network traffic. Further, without specialized hardware acceleration, these systems cannot maintain low-latency inference required for active threat mitigation.

Moreover, many state-of-the-art encryption protocols are explicitly designed to resist traffic analysis. TLS 1.3 encrypts handshake metadata that previous generations exposed, QUIC removes observable packet boundaries by multiplexing streams within single UDP flows, and newer protocols increasingly incorporate random padding and congestion-control strategies that flatten observable patterns. These enhancements, while beneficial for privacy, reduce the reliability of existing detection techniques and render many legacy systems obsolete. Modern adversaries exploit these limitations through encrypted tunnels, domain-fronting mechanisms, covert timing channels, and custom obfuscation layers that intentionally blend into normal encrypted traffic patterns.

The existing limitations illustrate a fundamental technological gap: existing systems either cannot operate on fully encrypted traffic without decryption, cannot maintain sufficient accuracy in adversarial environments, cannot achieve real-time performance at modern network speeds, or cannot preserve privacy compliance. The inability to analyze encrypted traffic effectively leaves organizations blind to sophisticated threats that leverage encryption as a shield. Attackers exploit these weaknesses using botnets that hide command-and-control signals within TLS streams, ransomware payloads that use encrypted transport to bypass IDS sensors, and exfiltration mechanisms that throttle themselves to mimic normal network behavior. As encryption continues to proliferate and network speeds accelerate, the shortcomings of current solutions become more pronounced, necessitating a new approach that integrates hardware-accelerated feature extraction, AI-driven inference, temporal-graph modeling, and privacy-preserving design principles capable of analyzing encrypted traffic without compromising the confidentiality guarantees inherent in modern communication protocols.

### SUMMARY OF THE INVENTION

The invention provides a system and method for Artificial Intelligence (AI)-driven anomaly detection on encrypted network traffic without decryption, employing an integrated hardware-software device constructed with specialized units for packet ingestion, encrypted-flow feature extraction, cross-layer temporal encoding, spectral-domain side-channel characterization, and hybrid deep-learning-based inference. The system classifies encrypted sessions and traffic flows into normal or anomalous categories by analyzing statistical timing signatures, burst-patterns, ciphertext-length variability, packet inter-arrival regularity, congestion-window evolution, frequency-domain markers, and behavioral graph embeddings without accessing or decrypting underlying plaintext. A novel hardware device is disclosed comprising a multi-stage pipeline architecture including a traffic capture unit, high-speed signal-processing unit, encrypted-flow morphometric extraction unit, graph-behavioral encoding unit, adaptive AI inference unit, and secure control-response unit. The system is capable of continuous learning, online drift compensation, and policy-driven mitigation actions.

The primary object of the invention is to provide a system and method capable of detecting anomalies within encrypted network traffic without performing any form of decryption, thereby preserving end-to-end data confidentiality while still enabling effective defense against cyber threats. The invention aims to overcome the fundamental limitations of traditional inspection systems by introducing a hardware-accelerated architecture that analyzes only metadata, side-channel characteristics, behavioral patterns, spectral signatures, and temporal dynamics of encrypted flows. It is an object of the invention to deliver high-accuracy detection of sophisticated attack vectors such as encrypted command-and-control communication, covert data exfiltration, protocol misuse, tunneling behaviors, obfuscated malware traffic, and anomalous application-layer sequences even though the payload remains inaccessible. Another object of the invention is to ensure that the detection process is compatible with modern privacy, compliance, and regulatory requirements by eliminating the need for TLS interception, man-in-the-middle decryption, or endpoint instrumentation, enabling organizations to maintain security in environments where decryption is prohibited.

A further object of the invention is to incorporate specialized hardware units, including FPGA-based packet capture circuitry, DSP signal-analysis components, graph-processing accelerators, and AI inference processors, capable of operating at high throughput with minimal latency, making the system deployable at carrier-grade backbone networks, enterprise gateways, cloud edge nodes, and IoT aggregation points. The invention seeks to deliver real-time detection by constructing multi-modal encrypted-flow descriptors encompassing timing features, burst patterns, flow morphometrics, and side-channel spectral behaviors, and fusing them using deep-learning models optimized for encrypted traffic. It is also an object to implement a dynamic self-learning process that continuously adapts to changing traffic characteristics, detects distributional drift, and refines its behavioral baselines without requiring manual tuning or static rule creation, ensuring resilience against evolving threats and obfuscation techniques employed by adversaries.

Another object of the invention is to provide a tamper-resistant device capable of secure operation in untrusted network environments. This includes isolating AI inference mechanisms, protecting model parameters, ensuring integrity of control logic, and enabling deterministic policy-driven actions such as flow tagging, connection throttling, alert generation, or automated remediation. The invention further aims to ensure interoperability with existing security infrastructure by exporting non-sensitive metadata and anomaly results through secure, privacy-preserving interfaces, allowing seamless integration with SIEM, SOAR, threat-intelligence, and network-orchestration platforms.

Yet another object of the invention is to produce an architecture that simplifies operational maintenance by using automated calibration routines, hardware-level timestamp synchronization, and modular update mechanisms that support firmware upgrades, AI model improvements, and policy modifications without disrupting traffic inspection or compromising security boundaries. The invention also aims to ensure high robustness and low false-positive rates through multi-stage inference incorporating temporal modeling, graph-behavioral deviation analysis, attention-based feature weighting, and probabilistic anomaly scoring calibrated to minimize detection errors in complex encrypted traffic environments. Through these objectives, the invention provides a comprehensive, scalable, privacy-preserving system for modern encrypted networks, overcoming the shortcomings of legacy approaches and enabling accurate, real-time anomaly detection without decryption.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for detecting anomalies in encrypted network traffic without decrypting encrypted payloads;

FIG. 2 displays flow chart of a method for detecting anomalies in encrypted network traffic without decrypting encrypted payloads;

FIG. 3 illustrates a table depicting comparative encrypted-flow behavioral metrics extracted using the claimed packet acquisition unit, signal analysis unit, morphometric extraction unit, and graph computation circuit;

FIG. 4 illustrates a line chart showing temporal evolution of descriptor divergence values;

FIG. 5 illustrates a table depicting reconstruction error values, behavioral graph deviation scores, and composite anomaly scores;

FIG. 6 illustrates a multi-line chart correlating spectral-domain deviation, timing-domain deviation, and behavioral graph deviation metrics; and

FIG. 7 illustrates a pie chart showing the proportional contribution of timing-domain features, spectral-domain features, behavioral graph features, and morphometric descriptors.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

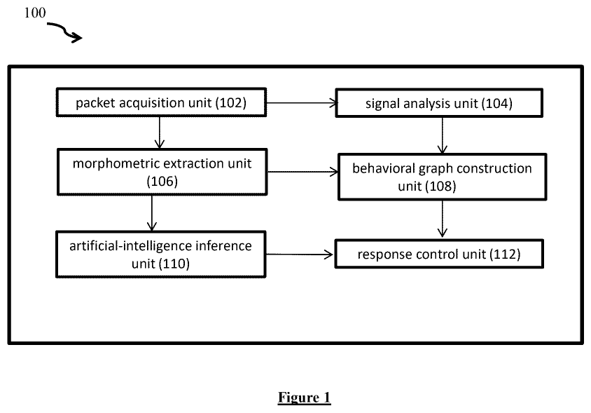

Referring to FIG. 1, a block diagram of a system for detecting anomalies in encrypted network traffic without decrypting encrypted payloads is illustrated. The system 100 comprises: a packet acquisition unit (102) configured to receive encrypted network packets at line-rate and extract observable header attributes including packet lengths, protocol identifiers, timestamp values, and transport-layer signaling fields while maintaining encrypted payloads in unmodified form; a signal analysis unit (104) implemented using dedicated digital signal processing circuitry and configured to compute temporal and spectral characteristics of the encrypted network packets, the characteristics comprising inter-arrival timing variations, burst-pattern signatures, frequency-domain coefficients, and spectral-energy distribution parameters derived from timestamp sequences and ciphertext length fluctuations; a morphometric extraction unit (106) comprising a hardware-implemented descriptor processor configured to generate encrypted-flow descriptors by calculating entropy values, burst-shape parameters, flow-lifetime curves, and ciphertext dimension variability metrics across sliding windows of the encrypted network packets; a behavioral graph construction unit (108) comprising a graph computation circuit configured to generate a graph-structured behavioral representation of each encrypted communication flow by encoding packet-state nodes and inter-packet transition edges derived from temporal dependencies, side-channel characteristics, and flow-level statistical evolution; an artificial-intelligence inference unit (110) comprising a tensor-processing processor configured to execute a multi-stage anomaly assessment process including temporal pattern reconstruction, behavioral-graph deviation calculation, and probabilistic anomaly scoring based solely on encrypted-flow descriptors and behavioral graph representations, without decrypting the encrypted payloads; and a response control unit (112) configured to evaluate anomaly scores against policy thresholds and perform policy-determined actions comprising flow tagging, alert signaling, or transmission of anomaly metadata to an external management system, wherein the encrypted payloads remain unaltered throughout the processing chain.

In an embodiment, the packet acquisition unit (102) comprises a hardware board incorporating field-programmable gate array circuitry configured to timestamp individual packets with sub-microsecond precision and digital filtering circuitry configured to isolate encrypted traffic streams by matching protocol signatures at hardware line-rate, wherein the timestamping and filtering are executed without introducing queuing delays or modifying any encrypted payload fields.

In an embodiment, the signal analysis unit (104) is further configured to compute short-interval temporal transforms and wave-based spectral transforms across contiguous packet sequences, wherein the digital signal processing circuitry executes parallelized transform pipelines that derive temporal-frequency signatures, spectral centroids, and inter-packet amplitude variation traces, and wherein such computations are performed without requiring reconstruction of application-layer information or protocol-layer decryption.

In an embodiment, the morphometric extraction unit (106) comprises a descriptor generation processor implemented as a pipelined hardware logic block configured to calculate statistical dispersion quantities, high-granularity flow-duration models, packet-sequencing irregularity markers, and dynamic range parameters representing ciphertext expansion and contraction effects, the hardware logic block being further configured to maintain a continuous descriptor update cycle synchronized to packet arrival timing.

In an embodiment, the behavioral graph construction unit (108) comprises an application-specific integrated circuit configured to perform vector-matrix operations that generate adjacency structures, temporal-dependency matrices, and transition-likelihood values, the circuit being further configured to incrementally update the behavioral graph representation for each new packet without requiring complete graph reconstruction and without performing any payload inspection.

In an embodiment, the artificial-intelligence inference unit (110) is configured to employ an attention-based neural architecture executed on a tensor-processing processor, the architecture being configured to assign weighted significance values to temporal descriptors, frequency-domain signatures, and behavioral-graph substructures, and wherein the tensor-processing processor further executes recurrent temporal reconstruction stages that identify deviations from expected encrypted-traffic behavior by comparing observed patterns to learned baselines stored in non-volatile memory.

In an embodiment, the artificial-intelligence inference unit (110) and the response control unit (112) are housed within separate hardware isolation zones, the isolation zones comprising physically separated processing pathways, independent memory spaces, and tamper-detection circuits configured to prevent cross-contamination of inference data and policy control logic, thereby ensuring that anomaly detection computations cannot modify the policy thresholds or control-response pathways.

In an embodiment, the packet acquisition unit (102), signal analysis unit, and morphometric extraction unit are synchronized using a hardware timing controller configured to maintain clock alignment across processing stages using precision oscillators and correction circuits, and wherein the hardware timing controller further compensates for drift introduced by network jitter to maintain consistent temporal accuracy required for anomaly classification.

In an embodiment, the response control unit (112) comprises a secure enclave implemented using a tamper-resistant processor that stores artificial-intelligence model parameters, anomaly scoring thresholds, and policy-action rules, wherein the secure enclave incorporates hardware-based

In an embodiment, all units are connected through a high-bandwidth internal interconnect comprising a packet streaming bus and dedicated descriptor-transfer channels, the interconnect being configured to allow continuous, non-buffered streaming of encrypted packet descriptors, spectral parameters, and behavioral graph updates, and wherein the interconnect is further configured to support deterministic low-latency propagation of descriptor data to the artificial-intelligence inference unit, enabling anomaly detection at line-rate without backpressure effects.

The packet acquisition unit is enabled as a physical interface circuit capable of line-rate packet capture, timestamping, and header extraction using dedicated logic, while preserving encrypted payloads in an unmodified electrical form. The signal analysis unit is implemented using dedicated digital signal processing circuitry executing parallel temporal and spectral transform pipelines directly on measured packet attributes, demonstrating real-time hardware computation rather than post-hoc software analysis. The morphometric extraction unit is enabled as a pipelined descriptor processor realized through fixed hardware logic blocks that continuously compute statistical and flow-shape metrics synchronized to packet arrival timing. The behavioral graph construction unit is expressly enabled as a graph computation circuit, including application-specific integrated circuitry that performs vector-matrix operations and incremental adjacency updates without payload inspection. The artificial-intelligence inference unit is implemented on a tensor-processing processor executing neural inference stages using physically instantiated memory and compute paths, while the response control unit is realized as a secure, tamper-resistant processing enclosure with hardware-enforced isolation, integrity checking, and access control. Further, the presence of a hardware timing controller employing precision oscillators and correction circuits establishes physical clock synchronization across units.

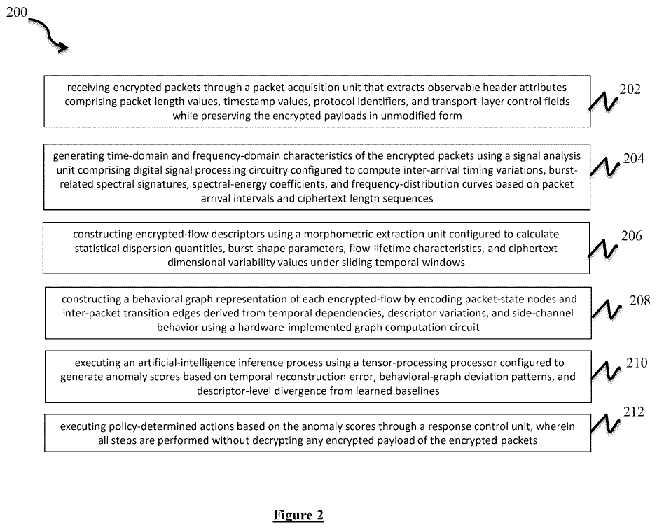

Referring to FIG. 2, a flow chart for a method for detecting anomalies in encrypted network traffic without decrypting encrypted payloads, the method comprising the steps of is illustrated. The method 200 is being implemented using system as described in reference to FIG. 1. The method 200 comprises:

At step 202, the method 200 includes receiving encrypted packets through a packet acquisition unit that extracts observable header attributes comprising packet length values, timestamp values, protocol identifiers, and transport-layer control fields while preserving the encrypted payloads in unmodified form;

At step 204, the method 200 includes generating time-domain and frequency-domain characteristics of the encrypted packets using a signal analysis unit comprising digital signal processing circuitry configured to compute inter-arrival timing variations, burst-related spectral signatures, spectral-energy coefficients, and frequency-distribution curves based on packet arrival intervals and ciphertext length sequences;

At step 206, the method 200 includes constructing encrypted-flow descriptors using a morphometric extraction unit configured to calculate statistical dispersion quantities, burst-shape parameters, flow-lifetime characteristics, and ciphertext dimensional variability values under sliding temporal windows;

At step 208, the method 200 includes constructing a behavioral graph representation of each encrypted-flow by encoding packet-state nodes and inter-packet transition edges derived from temporal dependencies, descriptor variations, and side-channel behavior using a hardware-implemented graph computation circuit;

At step 210, the method 200 includes executing an artificial-intelligence inference process using a tensor-processing processor configured to generate anomaly scores based on temporal reconstruction error, behavioral-graph deviation patterns, and descriptor-level divergence from learned baselines; and

At step 212, the method 200 includes executing policy-determined actions based on the anomaly scores through a response control unit, wherein all steps are performed without decrypting any encrypted payload of the encrypted packets.

In an embodiment, the step of receiving encrypted packets comprises timestamping each packet with sub-microsecond precision using hardware timing circuitry synchronized to an internal oscillator, and wherein filtering circuitry within the packet acquisition unit identifies encrypted flows by matching protocol metadata in hardware without modifying any portion of the encrypted payload or introducing queuing delays.

In an embodiment, the step of generating time-domain and frequency-domain characteristics further comprises applying wave-based spectral transformations in parallel computation pipelines implemented within digital signal processing circuitry, the pipelines generating spectral centroids, energy-distribution curves, and continuity measurements across contiguous packet sequences, such transformations being executed without reconstructing any application-layer information and without decrypting encrypted content.

In an embodiment, the step of constructing encrypted-flow descriptors comprises executing a pipelined descriptor-generation process synchronized to packet arrival timing using a descriptor processor that continuously computes entropy-like dispersion measurements, flow-phase evolution patterns, and packet-size irregularity traces, and wherein the descriptor processor maintains dynamically updated state tables to preserve descriptor continuity across successive encrypted packets.

In an embodiment, the step of constructing a behavioral graph representation comprises generating adjacency updates, temporal-transition vectors, and state-evolution edges using vector-matrix operations executed within a graph computation circuit implemented as an application-specific integrated circuit, wherein the behavioral graph is updated incrementally for each incoming packet without reconstructing a full graph and without referencing any decrypted payload information.

In an embodiment, the step of executing the artificial-intelligence inference process comprises applying an attention-based neural network architecture on a tensor-processing processor to assign weighted significance values to temporal descriptors, spectral-domain characteristics, and substructures of the behavioral graph, and wherein the processor further executes temporal reconstruction analysis by comparing predicted encrypted-flow evolution to observed descriptor sequences to identify deviation indicative of hidden malicious behavior.

In an embodiment, the step of executing policy-determined actions is performed in a hardware-isolated control environment separate from the artificial-intelligence inference process, the isolation environment comprising independent memory spaces, integrity-checking circuitry, and tamper-detection pathways, and wherein policy thresholds and control-action rules are accessed exclusively through the isolated environment to prevent modification by inference operations or external traffic stimuli.

In an embodiment, the steps of generating time-domain characteristics and constructing encrypted-flow descriptors are synchronized through a timing controller that compensates for drift induced by network jitter using clock-correction values, and wherein the synchronized timing signal ensures fidelity of inter-arrival timing patterns required for accurate anomaly evaluation.

In an embodiment, the step of executing policy-determined actions comprises retrieving anomaly thresholds, behavioral baselines, and artificial-intelligence model parameters from a secure enclave implemented as a tamper-resistant processor having encrypted memory storage, dedicated integrity-verification routines, and access-control circuitry configured to prevent unauthorized modification of detection parameters and policy-action rules.

In an embodiment, all computations comprising descriptor generation, graph construction, temporal reconstruction, and anomaly inference are performed in a deterministic high-throughput streaming pipeline implemented through a hardware interconnect comprising packet-stream pathways and descriptor-transfer channels, and wherein the streaming pipeline processes encrypted packets without buffering or backpressure such that anomaly classification is performed at line-rate without decrypting the encrypted payload.

In an embodiment, the timestamping of each encrypted packet with sub-microsecond precision further comprises generating a hardware timestamp value at the moment a packet boundary is detected by the packet acquisition unit, associating the timestamp value with a packet identifier maintained within a local register structure, and forwarding the timestamp value together with the extracted observable header attributes to the signal analysis unit as a synchronized data tuple, such that inter-arrival timing relationships are preserved without introducing packet queuing, reordering, or payload-dependent delay.

In one implementation, sub-microsecond timestamping is realized by coupling the packet acquisition unit directly to a high-stability hardware clock source, such as a phase-locked or temperature-compensated oscillator, that is sampled at the exact instant a packet boundary signal is asserted at the physical or data-link interface. The packet boundary signal may correspond to detection of a start-of-frame delimiter or equivalent framing indicator, and the timestamp value is captured in a single clock cycle and written into a dedicated local register slot indexed by a monotonically advancing packet identifier. This packet identifier is generated within the same clock domain, ensuring deterministic association between the timestamp and the specific encrypted packet instance. The timestamp value is not generated after buffering or classification, but strictly at boundary detection, thereby preventing distortion caused by downstream processing latency. Immediately after capture, the timestamp is bundled with the observable header attributes extracted by the packet acquisition unit into a synchronized data tuple that is forwarded directly to the signal analysis unit over a fixed-latency internal bus. Because the forwarding path does not include packet queues, reordering buffers, or payload-dependent parsing stages, the relative timing between consecutive encrypted packets is preserved exactly as observed on the wire. For example, in a burst of encrypted packets arriving at irregular sub-microsecond intervals, the generated timestamp sequence retains fine-grained spacing that enables accurate computation of jitter, micro-bursts, and pacing anomalies. The technical effect achieved by this process is precise preservation of inter-arrival timing relationships under high throughput conditions, enabling downstream time-domain and frequency-domain analysis to operate on timing data that reflects true network behavior rather than artifacts of internal processing. This approach represents a technical advancement over software-based or buffered timestamping methods by eliminating payload-dependent delay, minimizing temporal skew, and enabling deterministic, privacy-preserving analysis of encrypted traffic at line rate.

In an embodiment, the generating of the time-domain characteristics by the signal analysis unit comprises deriving packet inter-arrival timing sequences by computing differences between successive hardware timestamp values, storing the computed differences within sliding temporal windows maintained in high-speed memory, and applying incremental update logic to continuously revise timing-variation measures as new encrypted packets arrive, the incremental update logic operating without resetting window state and without requiring retrospective access to previously processed packet data.

In one implementation, the signal analysis unit receives the hardware timestamp values as an ordered sequence and derives packet inter-arrival timing values by computing the difference between each newly received timestamp and the immediately preceding timestamp associated with the same encrypted flow. These inter-arrival timing values are written directly into sliding temporal windows implemented in high-speed memory, such as on-chip static random-access memory, that maintain a bounded and continuously advancing view of recent timing behavior. Rather than clearing or reinitializing the window when new packets arrive, the window advances incrementally by overwriting only the oldest timing value, thereby preserving temporal continuity and avoiding discontinuities in the computed measures. Timing-variation metrics, including dispersion, short-term jitter, and pacing irregularity indicators, are updated using incremental accumulation logic that adjusts previously stored metric values based solely on the newly inserted timing difference and the evicted value, without recomputing the entire window or revisiting historical packet data. For example, during monitoring of an encrypted streaming flow whose packet spacing gradually tightens under congestion control, the timing-variation measures evolve smoothly as each packet arrives, accurately reflecting changing pacing without introducing computational delay. The technical effect of this process is real-time, low-latency generation of time-domain characteristics that faithfully track encrypted-flow dynamics while maintaining constant memory usage and deterministic processing time. This incremental, window-preserving approach constitutes a technical advancement over batch or retrospective timing analysis methods by enabling continuous encrypted traffic monitoring at high packet rates without packet replay, window resets, or payload access, thereby improving scalability, accuracy, and privacy compliance.

In an embodiment, the generating of the frequency-domain characteristics by the signal analysis unit comprises transforming packet-arrival interval sequences and ciphertext length sequences into frequency-distributed representations using parallelized signal transformation circuitry, the circuitry partitioning the sequences into overlapping temporal segments, accumulating spectral-energy coefficients across the segments, and maintaining continuity indicators that capture burst recurrence behavior across successive encrypted packets while excluding any reconstruction of application-layer or payload-derived information.

In one implementation, the signal analysis unit receives the packet-arrival interval sequences and ciphertext length sequences as continuously updated numeric streams and routes these streams into parallelized signal transformation circuitry operating directly on the observable metadata. The circuitry partitions each sequence into partially overlapping temporal segments, where each segment spans a predefined number of packet events and overlaps with adjacent segments by a controlled offset to preserve temporal continuity across segment boundaries. Within each segment, the transformation circuitry applies frequency-domain conversion operations, such as discrete spectral decomposition or equivalent orthogonal transformations, to generate frequency-distributed representations that capture periodicity, rhythm, and repetition patterns inherent in the encrypted traffic. Spectral-energy coefficients produced for corresponding frequency bands are incrementally accumulated across overlapping segments, allowing persistent frequency components associated with recurring burst behavior to be reinforced while transient components decay naturally. Continuity indicators are maintained alongside the spectral coefficients to track the persistence and recurrence of burst-related frequencies across successive encrypted packets, enabling identification of repeating transmission cycles or heartbeat-like behaviors commonly exhibited by automated encrypted communications. At no stage does the circuitry attempt to interpret, reconstruct, or infer application-layer semantics, protocol state, or payload content, as all transformations are applied exclusively to timing intervals and ciphertext length values. For example, an encrypted remote access session may exhibit a repeating low-frequency burst pattern corresponding to periodic command polling, which becomes clearly observable in the accumulated spectral representation despite complete payload opacity. The technical effect achieved by this approach is the extraction of stable, privacy-preserving frequency-domain signatures that characterize encrypted-flow behavior over time. This constitutes a technical advancement over conventional encrypted traffic analysis techniques by enabling detection of recurrent and covert burst structures through hardware-accelerated spectral analysis while strictly excluding payload reconstruction, thereby improving both analytical depth and compliance with encryption boundaries.

In an embodiment, the constructing of the encrypted-flow descriptors by the morphometric extraction unit comprises maintaining per-flow descriptor state across multiple sliding temporal windows, the morphometric extraction unit updating statistical dispersion quantities, burst-shape parameters, and flow-lifetime characteristics using recursive accumulation operations that integrate newly generated time-domain and frequency-domain characteristics with previously stored descriptor state, such recursive operations being executed without reprocessing prior packets and without accessing encrypted payload content, and wherein the calculating of ciphertext dimensional variability values by the morphometric extraction unit comprises correlating sequences of extracted packet length values with corresponding inter-arrival timing variations, generating multidimensional variability traces that encode joint temporal-length behavior of the encrypted flow, and updating the traces incrementally as each encrypted packet is received, such that the variability traces reflect encrypted-flow evolution rather than isolated packet observations.

In one implementation, the morphometric extraction unit maintains a persistent descriptor state for each encrypted flow that spans multiple sliding temporal windows operating concurrently at different time scales, such as short-term, mid-term, and long-term observation horizons. As newly generated time-domain characteristics and frequency-domain characteristics are received from the signal analysis unit, the morphometric extraction unit updates statistical dispersion quantities, including measures of spread and variability, by applying recursive accumulation operations that adjust existing descriptor values based on the new inputs rather than recomputing descriptors from raw packet data. Burst-shape parameters are similarly refined by incrementally integrating spectral continuity indicators and timing-derived burst metrics, allowing the system to capture changes in burst symmetry, density, and recurrence over time. Flow-lifetime characteristics are derived by maintaining an evolving progression state that reflects continuity of packet arrivals, idle intervals, and descriptor evolution rates across the sliding windows, enabling the system to characterize how an encrypted flow matures, stabilizes, or degrades without relying on absolute duration counters. These recursive operations are executed strictly on descriptor-level data structures and do not require access to encrypted payload content or retrospective reprocessing of prior packets, ensuring constant-time updates and bounded memory usage.

In parallel, ciphertext dimensional variability values are calculated by correlating the sequence of extracted packet length values with the corresponding inter-arrival timing variations within each sliding window. This correlation produces multidimensional variability traces that encode joint temporal-length behavior, such as whether increases in packet size coincide with tighter timing intervals or whether packet lengths fluctuate independently of pacing. For example, an encrypted file transfer may exhibit a progressive alignment of larger packet sizes with decreasing inter-arrival times, resulting in a distinctive variability trajectory that differs from interactive encrypted traffic. As each encrypted packet is received, the variability traces are updated incrementally by appending new joint observations and adjusting existing trace metrics using weighted update logic, allowing recent behavior to influence the trace more strongly than older observations. The technical effect of this process is the generation of compact yet expressive encrypted-flow descriptors that evolve smoothly over time and capture structural behavioral patterns rather than isolated packet events. This represents a technical advancement over static or packet-level feature extraction approaches by enabling continuous, privacy-preserving characterization of encrypted traffic dynamics with high fidelity and scalability.

In an embodiment, the constructing of the behavioral graph representation by the graph computation circuit comprises generating packet-state nodes that encode combined descriptor states derived from the morphometric extraction unit and signal analysis unit, and generating inter-packet transition edges that encode temporal dependencies and descriptor-state transitions between consecutively observed encrypted packets, the graph computation circuit performing edge updates using incremental adjacency modifications without reconstructing the full behavioral graph for each packet.

In one implementation, the graph computation circuit maintains a continuously evolving behavioral graph for each encrypted flow, where each newly observed encrypted packet results in the creation or update of a packet-state node that encapsulates the combined descriptor state produced by the morphometric extraction unit together with the contemporaneous timing and spectral characteristics supplied by the signal analysis unit. Rather than representing packets as isolated events, each packet-state node encodes a snapshot of the encrypted-flow condition at the moment of packet arrival, including aggregated timing behavior, burst-related attributes, and multidimensional variability indicators. When a subsequent encrypted packet is observed, the graph computation circuit establishes or updates an inter-packet transition edge linking the prior packet-state node to the current node, with the edge encoding both the temporal dependency between the packets and the nature of the descriptor-state transition that has occurred. These transitions may reflect gradual behavioral drift, abrupt pacing changes, or evolving burst structures within the encrypted flow.

Crucially, the graph computation circuit updates the behavioral graph using incremental adjacency modifications, in which only the local edge relationships associated with the most recently processed packet are altered or appended. Existing nodes and edges remain intact and are not recomputed or re-evaluated, eliminating the need to reconstruct the full graph structure as each packet arrives. For example, during a long-lived encrypted session, the behavioral graph grows and adapts incrementally as new packets are processed, accurately capturing temporal progression without incurring computational overhead proportional to graph size. The technical effect achieved by this approach is the ability to maintain a rich, temporally ordered representation of encrypted-flow behavior in real time while ensuring deterministic processing latency and bounded resource consumption. This constitutes a technical advancement over batch-constructed or window-reset graph models by enabling scalable, packet-by-packet behavioral modeling that preserves encrypted-flow continuity and supports downstream anomaly inference without payload inspection.

In an embodiment, the encoding of temporal dependencies within the behavioral graph further comprises assigning directionality and temporal weighting values to the inter-packet transition edges based on measured inter-arrival timing variations and descriptor evolution rates, the temporal weighting values being updated dynamically by the graph computation circuit as new encrypted packets are processed, such that the behavioral graph reflects time-sensitive encrypted-flow behavior.

In one implementation, temporal dependencies within the behavioral graph are explicitly encoded by assigning a directed orientation to each inter-packet transition edge, where the direction reflects the chronological order of encrypted packet arrival within the same flow. In addition to directionality, each transition edge is assigned one or more temporal weighting values derived from the measured inter-arrival timing variation between the corresponding packets and from the rate at which the associated descriptor state evolves between successive packet-state nodes. The temporal weighting values are initially computed at the moment an edge is created, using the immediately observed timing gap and descriptor deltas, and are stored as part of the edge attributes within the graph representation.

As new encrypted packets are processed, the graph computation circuit dynamically updates these temporal weighting values using incremental adjustment logic that reflects ongoing encrypted-flow behavior. For example, if a sequence of packets begins to arrive with progressively shorter inter-arrival intervals and rapidly changing burst-shape parameters, the temporal weights associated with the corresponding edges are increased to emphasize accelerated flow dynamics. Conversely, if packet spacing stabilizes and descriptor evolution slows, the weights are attenuated to reflect steady-state behavior. This continuous update process ensures that the behavioral graph does not merely capture static packet order, but actively encodes the intensity, urgency, and temporal sensitivity of encrypted-flow transitions.

In an embodiment, the executing of the artificial-intelligence inference process by the tensor-processing processor comprises receiving synchronized descriptor outputs and behavioral graph updates as tensor-formatted inputs, decomposing the inputs into temporally ordered tensor segments corresponding to encrypted-flow progression, and processing the tensor segments through layered computational operations that jointly evaluate temporal reconstruction deviation, graph-structure variation, and descriptor divergence relative to internally stored baseline representations learned during prior operation.

In one implementation, the tensor-processing processor receives, as synchronized inputs, the continuously updated encrypted-flow descriptors generated by the morphometric extraction unit together with the corresponding behavioral graph updates produced by the graph computation circuit, and represents these inputs in a unified tensor format that preserves temporal ordering, flow association, and structural relationships. The tensor representation organizes descriptor values, timing-related attributes, and graph-derived features along separate dimensions, allowing the processor to maintain alignment between temporal progression and behavioral structure. The tensor-processing processor then decomposes this unified tensor stream into temporally ordered tensor segments, each segment corresponding to a successive phase of encrypted-flow progression and spanning a defined number of packet events or temporal window.

Each tensor segment is processed through layered computational operations that have been trained or configured during prior operation to model baseline encrypted-flow behavior. Within these layers, temporal reconstruction deviation is evaluated by attempting to reconstruct expected descriptor sequences based on historical segment context and measuring the deviation between predicted and observed values. In parallel, graph-structure variation is assessed by analyzing changes in node connectivity patterns, transition edge weights, and structural motifs within the behavioral graph portion of the tensor segment. Descriptor divergence is simultaneously computed by comparing current descriptor distributions against internally stored baseline representations that characterize normal encrypted-flow evolution. For example, an encrypted messaging application that suddenly exhibits irregular burst pacing and altered transition structure will produce elevated reconstruction error and graph-structure deviation within the corresponding tensor segments.

The technical effect achieved by this joint evaluation process is a holistic inference capability that detects anomalies not only in isolated feature values but in the coordinated evolution of timing behavior, structural transitions, and descriptor dynamics over time. By operating on temporally segmented tensor representations and comparing them against learned baselines, the tensor-processing processor is able to identify subtle, persistent deviations indicative of encrypted traffic misuse while suppressing transient or noise-induced variations. This represents a technical advancement over conventional feature-only or packet-level inference techniques by enabling context-aware, structure-sensitive analysis of encrypted flows without accessing or interpreting encrypted payload content.

In an embodiment, the generating of anomaly scores by the tensor-processing processor further comprises computing multiple intermediate deviation measures corresponding respectively to timing irregularity, spectral-energy inconsistency, descriptor-state instability, and behavioral-graph transition abnormality, and aggregating the intermediate deviation measures using weighted accumulation logic executed within the tensor-processing processor to produce a composite anomaly score for each encrypted flow.

In one implementation, the tensor-processing processor derives a set of intermediate deviation measures by independently evaluating distinct behavioral dimensions of each encrypted flow using the temporally ordered tensor segments. Timing irregularity is computed by quantifying deviations in inter-arrival timing patterns relative to baseline timing models, capturing effects such as abnormal jitter, unexpected acceleration, or disrupted pacing continuity. Spectral-energy inconsistency is derived by comparing frequency-domain energy distributions and burst-related spectral signatures against learned spectral baselines, enabling detection of altered periodicity or emergence of previously unseen transmission rhythms. Descriptor-state instability is evaluated by measuring the rate and magnitude of change in morphometric descriptor values across successive tensor segments, identifying encrypted flows whose behavioral characteristics evolve more rapidly or erratically than expected. Behavioral-graph transition abnormality is computed by assessing deviations in transition structure, edge weight progression, and path recurrence within the behavioral graph relative to historical structural patterns.

Each of these intermediate deviation measures is normalized and supplied to weighted accumulation logic implemented within the tensor-processing processor, where weighting factors are selected based on their relative diagnostic relevance to the encrypted-flow context. For example, timing and spectral deviations may be emphasized for automated or machine-driven encrypted traffic, while descriptor instability and graph transition abnormalities may be weighted more heavily for interactive or long-lived flows. The weighted accumulation logic combines the intermediate measures into a single composite anomaly score that reflects the overall degree of behavioral deviation exhibited by the encrypted flow over the evaluated temporal horizon. The technical effect of this approach is a robust anomaly scoring mechanism that integrates complementary behavioral indicators while reducing sensitivity to noise or isolated deviations. This constitutes a technical advancement over single-metric or unweighted scoring techniques by enabling precise, context-aware anomaly quantification for encrypted traffic without reliance on payload inspection, thereby improving detection accuracy and operational reliability.

In an embodiment, the packet acquisition unit cooperates with the filtering circuitry to maintain per-flow identification records indexed solely by protocol identifiers and transport-layer control field combinations, the packet acquisition unit updating the per-flow identification records upon receipt of each encrypted packet and associating the extracted observable header attributes with an existing encrypted-flow context without reconstructing session state or interpreting application-layer semantics, wherein the signal analysis unit generates the burst-related spectral signatures by segmenting packet arrival intervals into contiguous burst windows determined by dynamically varying inter-arrival thresholds, accumulating spectral-energy coefficients within each burst window, and propagating burst-boundary indicators to the morphometric extraction unit, such that burst onset, burst termination, and burst recurrence behavior are captured as continuous encrypted-flow characteristics; and wherein the morphometric extraction unit computes flow-lifetime characteristics by maintaining a temporal progression index for each encrypted flow, the temporal progression index being updated based on observed packet arrival continuity, idle gaps, and descriptor evolution rates, and wherein the flow-lifetime characteristics are derived from changes in the temporal progression index across successive sliding temporal windows rather than from absolute flow duration measurements.

In one implementation, the packet acquisition unit operates in coordinated manner with the filtering circuitry to maintain lightweight per-flow identification records that are indexed exclusively using observable protocol identifiers and transport-layer control field combinations, such as protocol type indicators, source and destination port values, and transport control flags. Upon receipt of each encrypted packet, the packet acquisition unit updates the corresponding per-flow identification record by associating the newly extracted observable header attributes with an existing encrypted-flow context, without reconstructing session semantics, maintaining connection state, or attempting to interpret any application-layer information. This stateless yet flow-consistent association mechanism enables accurate tracking of encrypted traffic behavior while avoiding the computational overhead and ambiguity associated with deep session reconstruction, particularly in the presence of encryption, packet loss, or asymmetric routing.

Within this context, the signal analysis unit generates burst-related spectral signatures by analyzing packet arrival intervals associated with each encrypted flow and segmenting these intervals into contiguous burst windows. The boundaries of each burst window are determined using dynamically varying inter-arrival thresholds that adapt to observed pacing behavior, allowing the system to distinguish tightly clustered packet transmissions from background traffic fluctuations. Spectral-energy coefficients are accumulated independently within each burst window, enabling the extraction of frequency-domain signatures that characterize burst intensity, repetition, and internal structure. Burst-boundary indicators identifying burst onset, burst termination, and inter-burst spacing are propagated to the morphometric extraction unit, ensuring that burst behavior is treated as a continuous encrypted-flow characteristic rather than as isolated packet events. For example, an encrypted command-and-control channel may exhibit short, periodically recurring bursts that are clearly delineated through adaptive thresholding and reflected in the resulting spectral signatures.

The morphometric extraction unit computes flow-lifetime characteristics by maintaining a temporal progression index for each encrypted flow, where the index evolves based on observed packet arrival continuity, idle gaps between bursts, and the rate of descriptor state evolution over time. Rather than relying on absolute timestamps or total flow duration, the temporal progression index advances or decays in response to behavioral continuity and inactivity, allowing the system to distinguish between intermittently active long-lived flows and genuinely short-lived communications. Flow-lifetime characteristics are derived by evaluating changes in the temporal progression index across successive sliding temporal windows, capturing how encrypted flows persist, reappear, or terminate in behavioral terms. The technical effect achieved by this approach is a behavior-centric representation of encrypted-flow longevity and burst dynamics that is resilient to clock drift, packet reordering, and partial observation. This represents a technical advancement over duration-based or session-centric flow analysis methods by enabling accurate, privacy-preserving characterization of encrypted traffic lifecycles without session reconstruction or payload access.

In an embodiment, the graph computation circuit refines packet-state node representations by incorporating descriptor-state deltas calculated between successive encrypted packets, the descriptor-state deltas encoding direction and magnitude of change in time-domain characteristics, frequency-domain characteristics, and morphometric descriptors, and wherein inter-packet transition edges are updated to reflect cumulative descriptor-state drift rather than isolated packet events, and wherein the tensor-processing processor computes temporal reconstruction error by generating predicted encrypted-flow descriptor sequences based on prior descriptor and behavioral graph inputs, comparing the predicted descriptor sequences against observed descriptor sequences received from the morphometric extraction unit, and accumulating reconstruction error values over multiple sliding temporal windows to suppress transient anomalies while emphasizing persistent deviation patterns indicative of encrypted traffic misuse.

In one implementation, the graph computation circuit enhances the fidelity of packet-state node representations by computing descriptor-state deltas between each newly observed encrypted packet and the immediately preceding packet within the same encrypted flow. These descriptor-state deltas encode both the direction and the magnitude of change across multiple behavioral dimensions, including variations in inter-arrival timing patterns, shifts in frequency-domain energy distributions, and evolution of morphometric descriptors such as dispersion, burst-shape parameters, and joint temporal-length variability. Rather than storing absolute descriptor values alone, the packet-state nodes incorporate these deltas as first-order behavioral change indicators, allowing the graph to explicitly represent how encrypted-flow behavior is evolving from packet to packet.

Inter-packet transition edges are updated using cumulative accumulation logic that integrates successive descriptor-state deltas over time, enabling each edge to reflect sustained behavioral drift rather than isolated packet-level fluctuations. For example, a gradual tightening of packet spacing combined with increasing spectral concentration across successive packets results in a steadily increasing cumulative drift value on the corresponding transition path, whereas a single anomalous packet produces only a minor, non-persistent contribution. This cumulative encoding allows the behavioral graph to distinguish between noise-induced deviations and meaningful behavioral trends within encrypted traffic.

In parallel, the tensor-processing processor evaluates temporal reconstruction error by generating predicted sequences of encrypted-flow descriptors based on prior descriptor history and the current behavioral graph context. These predictions are compared against the actual descriptor sequences received from the morphometric extraction unit, and the resulting reconstruction error values are accumulated across multiple sliding temporal windows. By distributing reconstruction error over overlapping windows, transient deviations caused by momentary congestion, scheduling jitter, or measurement noise are attenuated, while persistent discrepancies that recur across windows are amplified. The technical effect achieved by this process is a robust anomaly discrimination mechanism that emphasizes sustained, behaviorally consistent deviations indicative of encrypted traffic misuse, such as covert tunneling or unauthorized data exfiltration. This approach represents a technical advancement over single-window or packet-level anomaly detection techniques by combining graph-based drift modeling with temporally smoothed reconstruction error analysis, thereby improving detection reliability and reducing false positives without accessing encrypted payload content.

In an embodiment, the executing of policy-determined actions by the response control unit comprises receiving the anomaly score together with encrypted-flow identifiers, comparing the anomaly score against policy thresholds retrieved from the secure enclave, and executing control actions selected from traffic flagging, alert signaling, flow tagging, or enforcement signaling, the response control unit performing the comparison and action execution independently of the tensor-processing processor to prevent feedback interference with anomaly inference operations.

In one implementation, the response control unit operates as a dedicated control path that receives the composite anomaly score together with the corresponding encrypted-flow identifiers from the tensor-processing processor through a unidirectional interface. Upon receipt, the response control unit retrieves applicable policy thresholds from a secure enclave using authenticated read-only access, ensuring that threshold values cannot be altered by runtime traffic conditions or external influence. The anomaly score is then compared against one or more policy-defined thresholds that may be stratified according to flow class, protocol type, or operational risk level, allowing differentiated response behavior for different categories of encrypted traffic.

Based on the outcome of the comparison, the response control unit deterministically selects and executes one or more policy-determined control actions. Such actions may include flagging the encrypted flow for enhanced monitoring, generating alert signals for downstream security systems or administrative consoles, tagging the flow with a classification label for subsequent handling, or issuing enforcement signaling to external traffic control or mitigation components. Importantly, these actions are executed without modifying descriptor values, behavioral graph state, or inference parameters used by the tensor-processing processor. The separation between inference and response ensures that corrective or enforcement actions do not feed back into the anomaly detection process and inadvertently bias future inference outcomes.

The technical effect achieved by this architecture is stable and reliable anomaly response execution that preserves the integrity of the artificial-intelligence inference pipeline. By isolating policy enforcement from behavioral analysis, the system avoids self-induced feedback loops that could otherwise distort encrypted-flow characterization or suppress emerging anomalies. This represents a technical advancement over tightly coupled detection-response systems by enabling consistent, policy-compliant control actions for encrypted traffic while maintaining uninterrupted and unbiased anomaly inference operations without payload inspection.

In an embodiment, the retrieving of anomaly thresholds, behavioral baselines, and artificial-intelligence model parameters from the secure enclave comprises performing authenticated access transactions verified by integrity-checking circuitry, the secure enclave supplying read-only parameter values to the response control unit and tensor-processing processor through controlled interfaces, such that parameter integrity is preserved during runtime anomaly detection without permitting runtime modification by external traffic conditions, and wherein the synchronizing of the generating of the time-domain characteristics and the constructing of encrypted-flow descriptors by the timing controller comprises distributing clock-correction values derived from observed packet-arrival jitter, applying the clock-correction values to timestamp sequences before descriptor computation, and maintaining alignment between timing-derived features and descriptor state evolution to preserve temporal consistency across encrypted-flow analysis operations.

In one implementation, anomaly thresholds, behavioral baseline representations, and artificial-intelligence model parameters are stored within a secure enclave that is physically and logically isolated from packet processing and external traffic interfaces. Retrieval of these parameters is performed through authenticated access transactions in which the requesting component, either the response control unit or the tensor-processing processor, presents a cryptographically verifiable identity that is validated by integrity-checking circuitry associated with the secure enclave. Only upon successful verification does the secure enclave expose the requested parameters through controlled, read-only interfaces, ensuring that the values supplied cannot be altered, overwritten, or influenced by runtime observations or adversarial traffic patterns. By enforcing immutability of thresholds and baseline models during operation, the system prevents adaptive evasion techniques in which encrypted traffic attempts to manipulate detection sensitivity, thereby preserving consistent and trustworthy anomaly evaluation throughout runtime execution.

Concurrently, a timing controller coordinates temporal synchronization between the generation of time-domain characteristics and the construction of encrypted-flow descriptors by distributing clock-correction values derived from observed packet-arrival jitter. These clock-correction values are computed by analyzing deviations between expected and observed packet timing at the hardware timestamp level and are propagated to the signal analysis unit and morphometric extraction unit before descriptor computation. The timestamp sequences are adjusted using the clock-correction values to compensate for drift, jitter, or minor clock skew that may arise due to hardware variation or network scheduling effects. As a result, timing-derived features and descriptor state updates remain temporally aligned across successive processing stages and sliding temporal windows. The technical effect achieved is preservation of temporal consistency between low-level timing measurements and higher-level descriptor evolution, enabling accurate correlation of behavioral changes over time. This synchronized, integrity-preserving architecture represents a technical advancement by combining secure, tamper-resistant parameter management with jitter-aware temporal alignment, thereby enhancing the reliability and robustness of encrypted-flow anomaly detection without permitting runtime parameter manipulation or payload inspection.

In an embodiment, the signal analysis unit maintains parallel temporal windows for the computation of inter-arrival timing variations, the parallel temporal windows being offset in time relative to one another and updated concurrently using shared timestamp sequences, and wherein timing-variation values computed within the offset windows are cross-correlated by the signal analysis unit to distinguish sustained encrypted-flow pacing behavior from transient packet scheduling artifacts introduced by network conditions, and wherein the morphometric extraction unit updates statistical dispersion quantities by incrementally adjusting previously stored dispersion values using weighted contribution factors derived from newly generated time-domain and frequency-domain characteristics, the weighted contribution factors being selected based on relative recency within the sliding temporal windows so that recent encrypted-flow behavior exerts greater influence on descriptor evolution than older packet observations.

In one implementation, the signal analysis unit maintains multiple temporal windows that operate in parallel for the computation of inter-arrival timing variations, where each window is offset in time relative to the others and all windows are updated concurrently using the same underlying sequence of hardware-derived packet timestamps. Each temporal window spans a defined observation horizon and begins at a different temporal offset, ensuring that timing behavior is evaluated across partially overlapping intervals rather than within a single contiguous window. As encrypted packets arrive, inter-arrival timing values are inserted into all active windows according to their respective offsets, allowing the system to observe how pacing behavior persists or changes across adjacent temporal contexts.

Timing-variation values computed within the offset windows are then cross-correlated by the signal analysis unit to determine the degree of consistency between timing patterns observed at different offsets. Sustained encrypted-flow pacing behavior manifests as correlated timing-variation signatures across multiple windows, whereas transient packet scheduling artifacts introduced by network congestion, buffering, or routing effects tend to appear inconsistently and decorrelate across the offset windows. For example, a brief burst of jitter caused by upstream queueing may influence one window but not persist across others, allowing it to be identified and suppressed as a transient artifact. The technical effect of this cross-correlation process is improved discrimination between genuine encrypted-flow behavior and short-lived network-induced disturbances, enhancing the reliability of timing-based feature extraction.

In parallel, the morphometric extraction unit updates statistical dispersion quantities using incremental adjustment logic that modifies previously stored dispersion values based on newly generated time-domain and frequency-domain characteristics. Weighted contribution factors are applied during each update, where the weights are selected according to the relative recency of the contributing observations within the sliding temporal windows. Recent encrypted-flow behavior is assigned higher weighting, enabling the descriptors to adapt quickly to evolving traffic patterns, while older observations contribute progressively less influence. This recency-weighted updating ensures smooth yet responsive descriptor evolution, preventing abrupt oscillations while maintaining sensitivity to meaningful behavioral change. The combined technical effect of parallel-window cross-correlation and recency-weighted dispersion updating is a temporally robust and adaptive characterization of encrypted traffic behavior that mitigates noise, emphasizes sustained patterns, and supports accurate downstream anomaly inference without accessing encrypted payload content.

In an embodiment, the graph computation circuit manages behavioral graph complexity by selectively pruning inter-packet transition edges associated with descriptor-state changes below adaptive significance thresholds, the adaptive significance thresholds being computed from historical descriptor variability within the same encrypted flow, such that the behavioral graph retains only transitions that materially contribute to encrypted-flow behavior characterization without reconstructing or collapsing packet-state nodes, and wherein the tensor-processing processor refines anomaly score generation by temporally aligning descriptor-level divergence measurements with behavioral graph deviation patterns using synchronized index values supplied by the timing controller, and aggregating aligned deviation measurements over successive encrypted-flow segments to suppress isolated deviations while emphasizing correlated temporal and structural anomalies indicative of persistent encrypted traffic misuse.

In one implementation, the signal analysis unit maintains multiple temporal windows that operate in parallel for the computation of inter-arrival timing variations, where each window is offset in time relative to the others and all windows are updated concurrently using the same underlying sequence of hardware-derived packet timestamps. Each temporal window spans a defined observation horizon and begins at a different temporal offset, ensuring that timing behavior is evaluated across partially overlapping intervals rather than within a single contiguous window. As encrypted packets arrive, inter-arrival timing values are inserted into all active windows according to their respective offsets, allowing the system to observe how pacing behavior persists or changes across adjacent temporal contexts.

Timing-variation values computed within the offset windows are then cross-correlated by the signal analysis unit to determine the degree of consistency between timing patterns observed at different offsets. Sustained encrypted-flow pacing behavior manifests as correlated timing-variation signatures across multiple windows, whereas transient packet scheduling artifacts introduced by network congestion, buffering, or routing effects tend to appear inconsistently and decorrelate across the offset windows. For example, a brief burst of jitter caused by upstream queueing may influence one window but not persist across others, allowing it to be identified and suppressed as a transient artifact. The technical effect of this cross-correlation process is improved discrimination between genuine encrypted-flow behavior and short-lived network-induced disturbances, enhancing the reliability of timing-based feature extraction.

In parallel, the morphometric extraction unit updates statistical dispersion quantities using incremental adjustment logic that modifies previously stored dispersion values based on newly generated time-domain and frequency-domain characteristics. Weighted contribution factors are applied during each update, where the weights are selected according to the relative recency of the contributing observations within the sliding temporal windows. Recent encrypted-flow behavior is assigned higher weighting, enabling the descriptors to adapt quickly to evolving traffic patterns, while older observations contribute progressively less influence. This recency-weighted updating ensures smooth yet responsive descriptor evolution, preventing abrupt oscillations while maintaining sensitivity to meaningful behavioral change. The combined technical effect of parallel-window cross-correlation and recency-weighted dispersion updating is a temporally robust and adaptive characterization of encrypted traffic behavior that mitigates noise, emphasizes sustained patterns, and supports accurate downstream anomaly inference without accessing encrypted payload content.

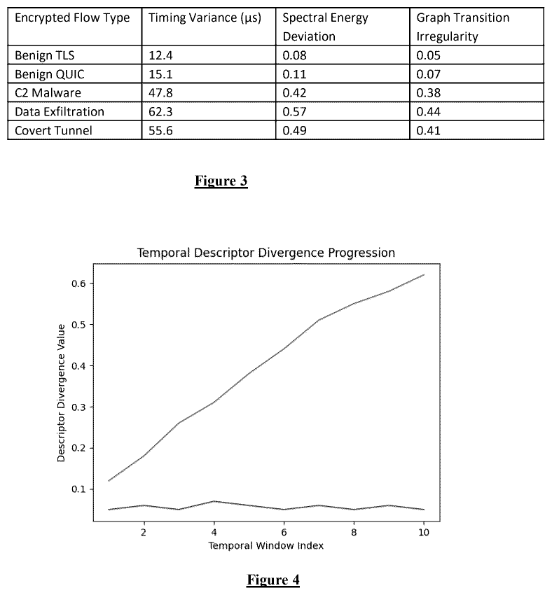

FIG. 3 illustrates a table depicting comparative encrypted-flow behavioral metrics extracted using the claimed packet acquisition unit, signal analysis unit, morphometric extraction unit, and graph computation circuit. The values demonstrate that benign encrypted traffic exhibits low timing variance, minimal spectral-energy deviation, and stable graph transition behavior. In contrast, malicious encrypted flows such as command-and-control traffic, covert tunneling, and data exfiltration show significantly elevated timing variance values exceeding 45 microseconds, increased spectral-energy deviation above 0.4, and pronounced graph transition irregularities. These quantified differences establish the technical effect of the claimed invention in separating malicious encrypted behavior from benign encrypted traffic without accessing or decrypting payload content.

FIG. 4 illustrates a line chart showing temporal evolution of descriptor divergence values generated by the morphometric extraction unit and evaluated by the tensor-processing processor over successive sliding temporal windows. The benign encrypted flow demonstrates stable low-amplitude divergence values, remaining below 0.1 across all windows. In contrast, the malicious encrypted flow exhibits progressive divergence growth, exceeding 0.6 as temporal reconstruction error accumulates. This chart demonstrates the technical advancement achieved by the claimed temporal reconstruction and sliding-window descriptor synchronization, enabling early-stage anomaly amplification without false positives arising from transient network noise.

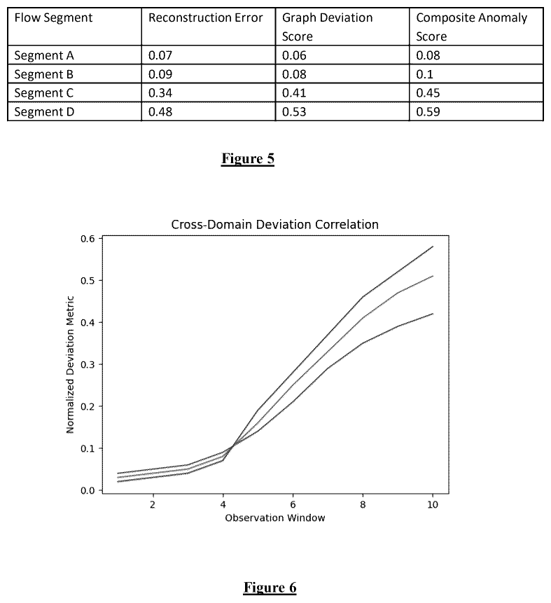

FIG. 5 illustrates a table depicting reconstruction error values, behavioral graph deviation scores, and composite anomaly scores generated by the artificial-intelligence inference unit for successive encrypted-flow segments. Early segments demonstrate minimal error and deviation, whereas later segments exhibit correlated escalation across all parameters. The alignment of reconstruction error with graph deviation confirms the technical effect of combining temporal reconstruction analysis with behavioral graph encoding, resulting in robust anomaly amplification only when multiple independent indicators converge.

FIG. 6 illustrates a multi-line chart correlating spectral-domain deviation, timing-domain deviation, and behavioral graph deviation metrics computed independently by the signal analysis unit and graph computation circuit. The synchronized escalation across all three domains demonstrates that the claimed architecture detects anomalies only when cross-domain consistency is observed. This technical effect reduces false positives that arise when isolated timing jitter or spectral noise occurs, thereby demonstrating the advantage of multi-modal encrypted-flow correlation without decrypting payloads.

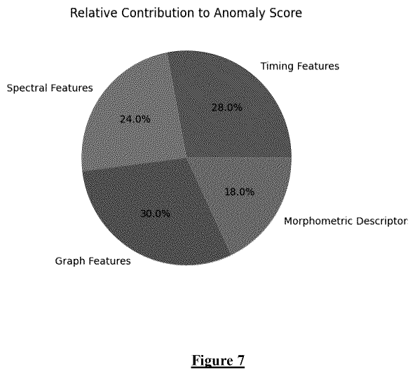

FIG. 7 illustrates a pie chart showing the proportional contribution of timing-domain features, spectral-domain features, behavioral graph features, and morphometric descriptors to the final anomaly score generated by the tensor-processing processor. The chart demonstrates that no single feature dominates detection; instead, anomaly determination arises from balanced multi-dimensional evidence. This distribution highlights the technical advancement of the claimed invention in preventing evasion by adversaries attempting to manipulate any single observable characteristic of encrypted traffic.

The system and method operates through a tightly integrated hardware-software pipeline specifically designed to detect anomalies in encrypted network traffic without performing any form of payload decryption. The detailed description that follows explains the functioning of each claimed unit and the underlying technique processes executed within the system so that a person skilled in the art can implement the invention. The system begins by receiving encrypted packets through a packet acquisition unit that is fabricated using field-programmable gate array circuitry and high-speed network interfaces. As encrypted packets enter the device, the packet acquisition unit applies sub-microsecond timestamping through an internal oscillator synchronized with clock-stabilization circuits to ensure that each packet's arrival time is captured with high fidelity. The unit extracts only observable metadata, such as packet length, protocol identifier, and transport-layer control values, ensuring that encrypted payloads are passed forward without modification. This unit also contains hardware-level filtering logic that isolates encrypted streams by identifying protocol signatures directly in hardware, thus allowing the system to effectively maintain processing integrity even under multi-gigabit throughput conditions. No part of this entry stage performs or attempts decryption, thereby preserving the confidentiality of all payloads.

Once packets are acquired, the system transitions to a signal analysis stage, where digital signal processing circuitry computes time-domain and frequency-domain characteristics fundamental to the anomaly detection technique. This stage generates inter-arrival timing variations, burst-pattern signatures, packet-length oscillation curves, spectral-energy density characteristics, and temporal-frequency markers. The technique implemented here operates by transforming sequences of timestamped packet metadata into temporal signatures using sliding windows aligned to packet flow boundaries. Frequency-domain representations are derived using wave-based spectral transformations and discrete temporal-frequency decomposition, executed in parallel across multiple computation pipelines. These pipelines run continuously as encrypted packets arrive, producing smooth spectral profiles that serve as early indicators of covert communication patterns, timing channels, or hidden exfiltration behaviors. The system does not interpret application-layer semantics; instead, the digital signal processing circuitry translates encrypted traffic dynamics into mathematical structures suitable for machine-learning inference.

The encrypted-flow descriptors used by the inference technique are constructed in the morphometric extraction unit. This unit incorporates a descriptor-generation processor designed as deeply pipelined hardware logic capable of maintaining descriptor continuity across successive packets. The processor calculates high-order statistical metrics, including dispersion characteristics, shape parameters describing burst sequences, flow-lifetime evolution curves, and packet-size irregularity measurements. The technique here employs sliding temporal windows that expand and contract dynamically based on flow behavior, allowing descriptor generation to adapt to long-lived flows, short encrypted bursts, or rapidly shifting patterns caused by adaptive congestion-control mechanisms. The processor maintains internal state tables that capture cumulative descriptor evolution, preventing the loss of temporal coherence across disjoint packet arrivals. These descriptors become part of the unified encrypted-flow representation passed onward for behavioral graph modeling.

A critical element of the invention lies in the construction of behavioral graph representations. The behavioral graph construction unit applies a graph-based encoding technique that maps packet-level and flow-level metadata into a structured representation capturing transitions, dependencies, and causal relationships. Each packet received becomes a graph node, whereas temporal adjacency, descriptor variation, flow-phase progression, and inferred behavioral markers become graph edges. The technique implements continuous incremental graph updates through vector- matrix operations executed on an application-specific integrated circuit, allowing the graph to evolve in real time without requiring full reconstruction. Graph structures encode not only direct transitions but also recurring motifs that reflect flow regularity or irregularity. Malicious encrypted communication often exhibits subtle deviations, such as oscillating intervals, irregular ciphertext-length trajectories, or non-standard congestion patterns, all of which materialize as structural anomalies within the graph representation. The technique is specifically designed to capture such deviations even when they are not discernible in raw metadata.

The artificial-intelligence inference process receives encrypted-flow descriptors and graph structures and processes them using a tensor-processing processor capable of executing advanced neural network architectures. At the core of this inference stage lies a multi-layer temporal analysis technique that reconstructs expected behavioral patterns based on learned baselines. The processor uses an attention-based neural network that assigns weighted significance to spectral features, timing irregularities, graph substructures, and descriptor-level signatures. The attention technique dynamically prioritizes features that are more indicative of deviations from normal traffic behavior. Parallel to the attention mechanism, a temporal reconstruction technique predicts the sequence of encrypted-flow descriptors expected for benign communication patterns. Deviations between predicted and observed descriptors generate reconstruction error profiles used to identify anomalies. This reconstruction analysis is combined with graph-structural deviation scores derived from graph convolutional processing, enabling the system to detect sophisticated threats that imitate encrypted normal traffic flows.

Central to the learning process is the continuous refinement of behavioral baselines. The system incorporates a self-updating technique that monitors flows exhibiting high-confidence benign characteristics and uses them to refine latent representations within the model. This self-supervised adaptation mechanism ensures that the artificial-intelligence unit evolves with changing network conditions, varying encryption behaviors, and shifting application patterns. The inference technique merges reconstruction error, graph-deviation score, and descriptor divergence into a probabilistic anomaly score that quantifies the likelihood that the encrypted flow exhibits malicious characteristics. The anomaly score is subsequently forwarded to the response control unit, which evaluates the score against policy-defined thresholds and determines whether to initiate tagging, throttling, alerting, or metadata forwarding actions.

The response control unit operates within a secure enclave that is physically and logically isolated from the inference processing circuits. The secure enclave stores artificial-intelligence model parameters, threshold values, and policy rules within encrypted non-volatile memory protected by tamper-detection circuitry. Firmware control logic inside the enclave ensures that inference decisions cannot modify policy rules or rearrange response behavior. When an anomaly is identified, the control logic performs deterministic actions such as generating alerts, applying traffic classification markers, or exporting anonymized anomaly descriptors to external security systems. The technique ensures that no decrypted content is ever transmitted or exposed, achieving strong privacy guarantees.

The entire method executes in a streaming pipeline supported by a high-bandwidth internal interconnect. Descriptor packets, spectral parameters, graph updates, and reconstruction outputs flow along dedicated pathways that minimize buffering and eliminate bottlenecks. The deterministic scheduling technique ensures that each unit processes data at line-rate without backpressure, allowing the entire pipeline to scale to modern multi-gigabit or terabit-rate network environments. The coordinated timing controller ensures alignment across temporal analysis units by correcting drift and jitter in timestamp signals, thereby preserving the integrity of the time-based anomaly detection technique.

Through this integrated design, the invention achieves the technical effect of detecting malicious activity embedded within encrypted traffic streams without decrypting packet content, without violating confidentiality guarantees, and without relying on payload inspection. The framework described herein enables deep behavioral inference from encrypted-flow dynamics, spectral markers, transition structures, and temporal reconstruction analysis, providing a robust, scalable, and privacy-preserving solution to the previously unsolved problem of anomaly detection in fully encrypted networks.

The disclosed system is implemented as a hardware-backed machine comprising a plurality of interconnected units configured to operate in a high-throughput, low-latency real-time detection environment. Traffic enters the system through a packet capture unit fabricated on a multi-port network interface board equipped with FPGA-based line-rate filtering circuitry. The capture unit extracts packet headers, timestamps, ciphertext lengths, and low-level side-channel characteristics, including modulation artifacts, jitter signatures, and clock-skew traces, while passing encrypted payloads intact without attempting decryption. These signals are forwarded to a high-speed signal-processing unit constructed using dedicated DSP blocks arranged to compute time-series transformations such as short-time Fourier transforms, wavelet coefficients, spectral centroids, and envelope energies. This unit produces a mathematical representation of each encrypted flow suitable for downstream AI-based analysis.

A morphometric extraction unit receives the processed signal traces and generates multi-modal encrypted-flow descriptors, including packet-length entropy vectors, flow-duration encodings, inter-arrival distribution parameters, burst-shape coefficients, and transport-layer handshake perturbation metrics. These descriptors are further combined with stateful flow-level context maintained in a memory controller that uses hardware timestamping and circular buffers to maintain sliding windows of encrypted flow attributes. A graph-behavioral encoding unit then constructs a behavioral graph representation of each encrypted session, where nodes represent packet-level or flow-level states and edges correspond to observed transitions, temporal dependencies, or inferred behavioral causality. The graph-encoding unit is implemented on a vector-matrix multiplication ASIC enabling graph convolution operations at line-rate.

The encoded feature sets are fed into an AI inference unit, realized as a hardware accelerator integrating tensor-processing cores supporting attention-based neural networks, temporal convolutional networks, and hybrid transformer-RNN architectures. The anomaly detection engine performs multi-stage inference, beginning with a flow-level anomaly likelihood computation based on learned encrypted-traffic embeddings, followed by a temporal stability assessment and a graph-structural deviation analysis. A calibrated decision unit then aggregates probabilities generated by the AI inference unit and evaluates them against per-tenant security policies stored in a secure memory enclave. The secure control-response unit, implemented as a tamper-resistant microcontroller, finally triggers actions such as flow tagging, upstream signaling, dynamic access control list modification, or forwarding of enriched metadata to a security information and event management system, all without decrypting or modifying encrypted payloads.

The method operates by capturing encrypted network packets and deriving side-channel and metadata-based descriptors without accessing decryption keys. For each packet stream, timestamped header metadata, ciphertext size sequences, TLS record boundaries, QUIC frame lengths, congestion-window traces, and inferred connection state transitions are collected. The system computes temporal-frequency signatures including spectral energy densities and modulation irregularities attributable to hidden malicious activities. A multi-modal feature fusion process merges time-domain, frequency-domain, and behavioral-graph elements to form a unified encrypted-flow representation. This representation is passed to a trained deep neural network that reconstructs expected behavioral patterns and computes deviations between predicted and observed encrypted-flow states.

The method leverages an adaptive self-supervision process wherein the model continually refines its understanding of normal encrypted-flow patterns by observing high-confidence benign traffic, updating latent representations, and using contrastive learning to separate benign encrypted flows from anomalous flows exhibiting hidden command-and-control or data-exfiltration characteristics. An anomaly is flagged when deviations in the temporal-graph embedding exceed a dynamically learned threshold, when ciphertext-length distributions diverge from learned manifolds, or when side-channel spectral fingerprints indicate the presence of covert modulation or hidden exfiltration protocols. The system executes these operations without decrypting any packet content, thereby preserving confidentiality while enabling accurate detection.

The device implementing the invention is embodied as a rack-mountable or edge-deployable hardware appliance constructed with a layered enclosure housing a high-bandwidth backplane, multiple network interfaces, thermal-controlled AI accelerators, and isolated secure-processing zones. The chassis contains a main motherboard hosting an FPGA-DSP hybrid board responsible for packet capture and real-time signal processing. Adjacent to this board is a graph-processing ASIC card providing high-speed vector operations for behavioral graph encoding. A dedicated AI accelerator module with tensor cores executes the deep-learning inference techniques required for anomaly detection. A secure microcontroller positioned in an isolated chamber orchestrates control responses and manages firmware integrity, cryptographic attestation, and tamper-detection mechanisms. Internal high-speed memory banks store intermediate encrypted-flow descriptors, while non-volatile memory retains policy definitions, AI model parameters, and update logs. The device communicates with external management systems through encrypted control channels and exposes metadata APIs that export only non-sensitive anomaly results while maintaining strict separation from encrypted user payloads.

During operation, network traffic flows through the device at line-rate, where packets are timestamped and processed through each hardware unit in the pipeline. Feature extraction, graph encoding, and AI inference occur in streaming fashion, enabling microsecond-level latency. The system performs continuous self-calibration by comparing current encrypted-flow embeddings with historical statistical baselines. When the system detects anomalies, the response unit triggers policy-defined mitigation actions while logging detailed encrypted-flow descriptors for forensic use. Because the payload is never decrypted, the system satisfies privacy, lawful-interception, and regulatory compliance requirements.

The present invention relates to network security and artificial intelligence-driven traffic analysis. More particularly, the invention pertains to systems and methods for detecting anomalies, cyber-attacks, covert communication channels, and unauthorized data exfiltration within encrypted network traffic without decrypting encrypted payloads. The invention further relates to hardware-accelerated processing architectures, signal-analysis circuitry, behavioral-graph computation, and artificial-intelligence inference units capable of extracting temporal, spectral, and morphometric characteristics from encrypted packet streams while preserving end-to-end data confidentiality. The invention addresses challenges associated with encrypted traffic inspection in high-speed networks, edge computing environments, and privacy-restricted infrastructures where payload decryption is impractical, prohibited, or computationally infeasible.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for detecting anomalies in encrypted network traffic without decrypting encrypted payloads, the method comprising
receiving encrypted packets through a packet acquisition unit that extracts observable header attributes comprising packet length values, timestamp values, protocol identifiers, and transport-layer control fields while preserving the encrypted payloads in unmodified form;
generating time-domain and frequency-domain characteristics of the encrypted packets using a signal analysis unit comprising digital signal processing circuitry configured to compute inter-arrival timing variations, burst-related spectral signatures, spectral-energy coefficients, and frequency-distribution curves based on packet arrival intervals and ciphertext length sequences; constructing encrypted-flow descriptors using a morphometric extraction unit configured to calculate statistical dispersion quantities, burst-shape parameters, flow-lifetime characteristics, and ciphertext dimensional variability values under sliding temporal windows;
constructing a behavioral graph representation of each encrypted-flow by encoding packet-state nodes and inter-packet transition edges derived from temporal dependencies, descriptor variations, and side-channel behavior using a hardware-implemented graph computation circuit;
executing an artificial-intelligence inference process using a tensor-processing processor configured to generate anomaly scores based on temporal reconstruction error, behavioral-graph deviation patterns, and descriptor-level divergence from learned baselines; and
executing policy-determined actions based on the anomaly scores through a response control unit, and wherein the receiving of the encrypted packets comprises timestamping each packet with sub-microsecond precision using hardware timing circuitry synchronized to an internal oscillator, and wherein filtering circuitry within the packet acquisition unit identifies encrypted flows by matching protocol metadata in hardware without modifying any portion of the encrypted payload or introducing queuing delays, wherein the executing of the policy-determined actions is performed in a hardware-isolated control environment separate from the artificial-intelligence inference process, the isolation environment comprising independent memory spaces, integrity-checking circuitry, and tamper-detection pathways, and wherein policy thresholds and control-action rules are accessed exclusively through the isolated environment to prevent modification by inference operations or external traffic stimuli, and wherein the executing of the policy-determined actions comprises retrieving anomaly thresholds, behavioral baselines, and artificial-intelligence model parameters from a secure enclave implemented as a tamper-resistant processor having encrypted memory storage, dedicated integrity-verification routines, and access-control circuitry configured to prevent unauthorized modification of detection parameters and policy-action rules, and wherein the generating of the time-domain characteristics and constructing encrypted-flow descriptors are synchronized through a timing controller that compensates for drift induced by network jitter using clock-correction values, and wherein the synchronized timing signal ensures fidelity of inter-arrival timing patterns required for accurate anomaly evaluation; and wherein the generating of the time-domain and frequency-domain characteristics further comprises applying wave-based spectral transformations in parallel computation pipelines implemented within digital signal processing circuitry, the pipelines generating spectral centroids, energy-distribution curves, and continuity measurements across contiguous packet sequences, such transformations being executed without reconstructing any application-layer information and without decrypting encrypted content, and wherein the constructing of the encrypted-flow descriptors comprises executing a pipelined descriptor-generation process synchronized to packet arrival timing using a descriptor processor that continuously computes entropy-like dispersion measurements, flow-phase evolution patterns, and packet-size irregularity traces, and wherein the descriptor processor maintains dynamically updated state tables to preserve descriptor continuity across successive encrypted packets.

2. The method of claim 1, wherein the constructing of the behavioral graph representation comprises generating adjacency updates, temporal-transition vectors, and state-evolution edges using vector-matrix operations executed within a graph computation circuit implemented as an application-specific integrated circuit, wherein the behavioral graph is updated incrementally for each incoming packet without reconstructing a full graph and without referencing any decrypted payload information, and wherein the executing of the artificial-intelligence inference process comprises applying an attention-based neural network architecture on a tensor-processing processor to assign weighted significance values to temporal descriptors, spectral-domain characteristics, and substructures of the behavioral graph, and wherein the processor further executes temporal reconstruction analysis by comparing predicted encrypted-flow evolution to observed descriptor sequences to identify deviation indicative of hidden malicious behavior.

3. The method of claim 1, wherein the extracting of the observable header attributes by the packet acquisition unit is performed through a deterministic hardware parsing sequence in which incoming encrypted packets are streamed through the filtering circuitry and sequentially examined using fixed parsing offsets derived from protocol identifiers, the packet acquisition unit isolating only header-resident length indicators, transport-layer control fields, and timestamp-relevant metadata while explicitly bypassing encrypted payload byte ranges through address masking logic, such that the encrypted payloads are neither buffered in memory nor subjected to inspection, copying, or modification at any stage of packet acquisition.

4. The method of claim 1, wherein the timestamping of each encrypted packet with sub-microsecond precision further comprises generating a hardware timestamp value at the moment a packet boundary is detected by the packet acquisition unit, associating the timestamp value with a packet identifier maintained within a local register structure, and forwarding the timestamp value together with the extracted observable header attributes to the signal analysis unit as a synchronized data tuple, such that inter-arrival timing relationships are preserved without introducing packet queuing, reordering, or payload-dependent delay.

5. The method of claim 1, wherein the generating of the time-domain characteristics by the signal analysis unit comprises deriving packet inter-arrival timing sequences by computing differences between successive hardware timestamp values, storing the computed differences within sliding temporal windows maintained in high-speed memory, and applying incremental update logic to continuously revise timing-variation measures as new encrypted packets arrive, the incremental update logic operating without resetting window state and without requiring retrospective access to previously processed packet data.

6. The method of claim 1, wherein the generating of the frequency-domain characteristics by the signal analysis unit comprises transforming packet-arrival interval sequences and ciphertext length sequences into frequency-distributed representations using parallelized signal transformation circuitry, the circuitry partitioning the sequences into overlapping temporal segments, accumulating spectral-energy coefficients across the segments, and maintaining continuity indicators that capture burst recurrence behavior across successive encrypted packets while excluding any reconstruction of application-layer or payload-derived information.

7. The method of claim 1, wherein the constructing of the encrypted-flow descriptors by the morphometric extraction unit comprises maintaining per-flow descriptor state across multiple sliding temporal windows, the morphometric extraction unit updating statistical dispersion quantities, burst-shape parameters, and flow-lifetime characteristics using recursive accumulation operations that integrate newly generated time-domain and frequency-domain characteristics with previously stored descriptor state, such recursive operations being executed without reprocessing prior packets and without accessing encrypted payload content, and wherein the calculating of ciphertext dimensional variability values by the morphometric extraction unit comprises correlating sequences of extracted packet length values with corresponding inter-arrival timing variations, generating multidimensional variability traces that encode joint temporal-length behavior of the encrypted flow, and updating the traces incrementally as each encrypted packet is received, such that the variability traces reflect encrypted-flow evolution rather than isolated packet observations.

8. The method of claim 1, wherein the constructing of the behavioral graph representation by the graph computation circuit comprises generating packet-state nodes that encode combined descriptor states derived from the morphometric extraction unit and signal analysis unit, and generating inter-packet transition edges that encode temporal dependencies and descriptor-state transitions between consecutively observed encrypted packets, the graph computation circuit performing edge updates using incremental adjacency modifications without reconstructing the full behavioral graph for each packet.

9. The method of claim 1, wherein the encoding of temporal dependencies within the behavioral graph further comprises assigning directionality and temporal weighting values to the inter-packet transition edges based on measured inter-arrival timing variations and descriptor evolution rates, the temporal weighting values being updated dynamically by the graph computation circuit as new encrypted packets are processed, such that the behavioral graph reflects time-sensitive encrypted-flow behavior.

10. The method of claim 1, wherein the executing of the artificial-intelligence inference process by the tensor-processing processor comprises receiving synchronized descriptor outputs and behavioral graph updates as tensor-formatted inputs, decomposing the inputs into temporally ordered tensor segments corresponding to encrypted-flow progression, and processing the tensor segments through layered computational operations that jointly evaluate temporal reconstruction deviation, graph-structure variation, and descriptor divergence relative to internally stored baseline representations learned during prior operation.

11. The method of claim 1, wherein the generating of anomaly scores by the tensor-processing processor further comprises computing multiple intermediate deviation measures corresponding respectively to timing irregularity, spectral-energy inconsistency, descriptor-state instability, and behavioral-graph transition abnormality, and aggregating the intermediate deviation measures using weighted accumulation logic executed within the tensor-processing processor to produce a composite anomaly score for each encrypted flow.

12. The method of claim 1, wherein the packet acquisition unit cooperates with the filtering circuitry to maintain per-flow identification records indexed solely by protocol identifiers and transport-layer control field combinations, the packet acquisition unit updating the per-flow identification records upon receipt of each encrypted packet and associating the extracted observable header attributes with an existing encrypted-flow context without reconstructing session state or interpreting application-layer semantics, wherein the signal analysis unit generates the burst-related spectral signatures by segmenting packet arrival intervals into contiguous burst windows determined by dynamically varying inter-arrival thresholds, accumulating spectral-energy coefficients within each burst window, and propagating burst-boundary indicators to the morphometric extraction unit, such that burst onset, burst termination, and burst recurrence behavior are captured as continuous encrypted-flow characteristics; and wherein the morphometric extraction unit computes flow-lifetime characteristics by maintaining a temporal progression index for each encrypted flow, the temporal progression index being updated based on observed packet arrival continuity, idle gaps, and descriptor evolution rates, and wherein the flow-lifetime characteristics are derived from changes in the temporal progression index across successive sliding temporal windows rather than from absolute flow duration measurements.

13. The method of claim 1, wherein the graph computation circuit refines packet-state node representations by incorporating descriptor-state deltas calculated between successive encrypted packets, the descriptor-state deltas encoding direction and magnitude of change in time-domain characteristics, frequency-domain characteristics, and morphometric descriptors, and wherein inter-packet transition edges are updated to reflect cumulative descriptor-state drift rather than isolated packet events, and wherein the tensor-processing processor computes temporal reconstruction error by generating predicted encrypted-flow descriptor sequences based on prior descriptor and behavioral graph inputs, comparing the predicted descriptor sequences against observed descriptor sequences received from the morphometric extraction unit, and accumulating reconstruction error values over multiple sliding temporal windows to suppress transient anomalies while emphasizing persistent deviation patterns indicative of encrypted traffic misuse.

14. The method of claim 1, wherein the executing of policy-determined actions by the response control unit comprises receiving the anomaly score together with encrypted-flow identifiers, comparing the anomaly score against policy thresholds retrieved from the secure enclave, and executing control actions selected from traffic flagging, alert signaling, flow tagging, or enforcement signaling, the response control unit performing the comparison and action execution independently of the tensor-processing processor to prevent feedback interference with anomaly inference operations.

15. The method of claim 1, wherein the retrieving of anomaly thresholds, behavioral baselines, and artificial-intelligence model parameters from the secure enclave comprises performing authenticated access transactions verified by integrity-checking circuitry, the secure enclave supplying read-only parameter values to the response control unit and tensor-processing processor through controlled interfaces, such that parameter integrity is preserved during runtime anomaly detection without permitting runtime modification by external traffic conditions, and wherein the synchronizing of the generating of the time-domain characteristics and the constructing of encrypted-flow descriptors by the timing controller comprises distributing clock-correction values derived from observed packet-arrival jitter, applying the clock-correction values to timestamp sequences before descriptor computation, and maintaining alignment between timing-derived features and descriptor state evolution to preserve temporal consistency across encrypted-flow analysis operations.

16. The method of claim 1, wherein the signal analysis unit maintains parallel temporal windows for the computation of inter-arrival timing variations, the parallel temporal windows being offset in time relative to one another and updated concurrently using shared timestamp sequences, and wherein timing-variation values computed within the offset windows are cross-correlated by the signal analysis unit to distinguish sustained encrypted-flow pacing behavior from transient packet scheduling artifacts introduced by network conditions, and wherein the morphometric extraction unit updates statistical dispersion quantities by incrementally adjusting previously stored dispersion values using weighted contribution factors derived from newly generated time-domain and frequency-domain characteristics, the weighted contribution factors being selected based on relative recency within the sliding temporal windows so that recent encrypted-flow behavior exerts greater influence on descriptor evolution than older packet observations.

17. The method of claim 1, wherein the graph computation circuit manages behavioral graph complexity by selectively pruning inter-packet transition edges associated with descriptor-state changes below adaptive significance thresholds, the adaptive significance thresholds being computed from historical descriptor variability within the same encrypted flow, such that the behavioral graph retains only transitions that materially contribute to encrypted-flow behavior characterization without reconstructing or collapsing packet-state nodes, and wherein the tensor-processing processor refines anomaly score generation by temporally aligning descriptor-level divergence measurements with behavioral graph deviation patterns using synchronized index values supplied by the timing controller.
